(19) United States
(12) Patent Application Publication
(10) Pub. No.: US 2002/0170066 A1
(43) Pub. Date: Nov. 14, 2002

(54) Method and apparatus for displaying internet content on a television

(76) Inventor: Meng-Hsien Liu, Taoyuan (TW)

Correspondence Address: J.C. Patents, Inc., 1340 Reynolds Ave., Suite 114, Irvine, CA, 92614, US

(21) Appl. No.: 09/927,798

(22) Filed: Aug. 10, 2001

Related U.S. Application Data
(60) Provisional application No. 60/290,469, filed on May 11, 2001.

(51) Int. Cl. G06F 3/00; H04N 5/445; G06F 13/00; H04N 7/173

(52) U.S. Cl. 725/109; 725/110; 725/51

(57) ABSTRACT

An internet-television system includes a web appliance that adds graphical lines and identifiers to internet content displayed on a television. Internet content is often difficult to view on a television screen due to factors such as poor resolution, further viewing distance, high definition graphics etc. The invention provides a web appliance with means to add graphical lines and identifiers to displayed internet content. The graphical lines breaks the internet content into a plurality of sections each with a corresponding identifier. A user can then input an identifier using a device such as a remote control. A section corresponding to the identifier can then be enlarged for easier viewing. In another embodiment of the invention a link appearing in a section can be selecting by inputting a corresponding identifier.

### CROSS-REFERENCE TO RELATED APPLICATION

This application claims the priority benefit of U.S. provisional application serial No. 60/290,469, filed May 11, 2001.

FIELD OF THE INVENTION

The present invention relates to a method and apparatus for viewing internet on a television and more specifically a method and apparatus for enlarging and selecting internet content on a television.

### BACKGROUND OF INVENTION

Use of the internet is becoming ever more widespread, and increasingly important in our daily lives. The internet allows users unparalleled access to information around the world via its huge network of connected computers. Most internet users use the World Wide Web WWW to access information whether it be text, sound, images or other actions. Currently most internet users use personal computers consisting of high speed microprocessors, accompanying peripherals, high definition computer monitors, and a modem connected to a telephone line or other communications means. However there still exists a large segment of the population (more so in less developed countries) that do not have a personal computer or access to the internet. Many of these households however do have a television and an ability to connect to the internet (e.g. phone line). Even for people who do have a personal computer, exploring the internet in the same way they view television can be very appealing due to factors such as greater comfort. Therefore a need exists for an internet device that can display information on a normal television screen. Many problems exist with this implementation however. In a typical computer environment, computer users choose to explore the internet using a mouse wherein a representative object such as a cursor can have its movement on a graphical interface controlled by hand movement. The representative object can be placed over specialized areas on the screen and though the clicking of a button on the mouse an object can be chosen. A keyboard is also used for typing website addresses, search keywords, tabbing between links and so forth. Television users view their television for entertainment purposes and do not find it convenient to use a computer mouse or keyboard. Therefore a need exists for a simple convenient method for viewing and browsing the internet.

Another major problem in implementing PC graphics on a television screen are the resolution differences. PC graphics standards such as VGA utilize 640 pixels horizontally across with 480 pixels vertically down, while television standards such as NTSC, PAL, or SECAM use a much lower resolution. Also PC graphics standards adopt a non-interlaced, progressive scan format, while TV standards adopt an interlaced scan format which creates flicker problems in the converted image. While many methods exists such as prior scaling and flicker reduction techniques the resolution and quality of an internet image on a television screen can still be difficult to discern. This problem is compounded by the fact that while computer users usually view the computer screen from a fairly standard close distance, television users usually view the television from farther distances that depend on a user. These factors combined with the fine detail in many web pages can make it very difficult to view internet data on a television screen. Therefore a need exists for a method to conveniently view the internet on a television screen.

### SUMMARY OF THE INVENTION

A primary goal of the invention is to provide a method and apparatus for viewing internet content on a television screen.

It is another object of the invention to provide a method for enlarging an area of internet content as it appears on a television screen for easier viewing.

It is yet another object of the invention to provide methods for selecting links as displayed in internet content on a television screen.

The basic system consists of a television connected to a web appliance. The web appliance is connected to the internet and can display internet content on the television. A plurality of graphical lines are added to the internet content as viewed on the television screen dividing the screen into 9 different “sections” each with an identifier. In one embodiment of the invention a user can input an identifier to the web appliance using a remote control. The section of the screen corresponding to the identifier will then be enlarged for easier viewing of the desired area. The user can then choose to further enlarge the current screen using the same method, or can return to the original descaled version of the screen.

In another embodiment of the invention a link appearing in section of the screen can be chosen by inputting the identifier to the web appliance that corresponds to the section in which the link appears.

### BRIEF DESCRIPTION OF DRAWINGS

FIG. 1 shows an example of an internet-television system

FIG. 2 shows an embodiment of the divisions of a display of internet content on a television screen.

FIG. 3 shows an example of the area enlarged for section 1.

FIG. 4 shows an example of the area enlarged for section 2.

FIG. 5 shows an example of the area enlarged for section 3.

FIG. 6 shows an example of the area enlarged for section 4.

FIG. 7 shows an example of the area enlarged for section 5.

FIG. 8 shows an example of the area enlarged for section 6.

FIG. 9 shows an example of the area enlarged for section 7.

FIG. 10 shows an example of the area enlarged for section 8.

FIG. 11 shows an example of the area enlarged for section 9.

FIG. 12 shows an example web page showing the divided sections.

FIG. 13 shows an example web page showing the divided sections and identified links.

### DETAILED DESCRIPTION

In the following detailed description of the preferred embodiments, reference is made to the accompanying drawings which form a part hereof, and in which is shown by way of illustration specific preferred embodiments in which the invention may be practiced. The preferred embodiments are described in sufficient detail to enable these skilled in the art to practice the invention, and it is to be understood that other embodiments may be utilized and that logical, changes may be made without departing from the spirit and scope of the present invention. The following detailed description is, therefore, not to be taken in a limiting sense, and the scope of the present invention is defined only be the appended claims.

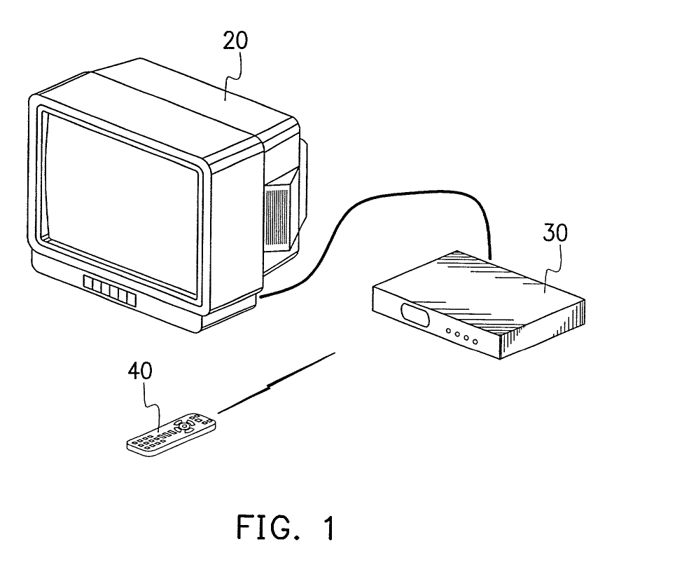

Today the World Wide Web is the dominant multimedia information retrieval system on the internet. The internet includes a massive collective of documents that are linked together. Most information (e.g. text, graphics, images, sound, video etc.) are transferred using the Hypertext Transfer Protocol (HTTP). HTTP further uses a standard page description language known as Hypertext Markup Language (HTML). HTML is used for marking documents to indicate how a document should be displayed, and how different documents should be linked together. Links usually appear as highlighted text known as the anchor of the link. Links can also be pictures, icons, or graphics that can be selected. The present invention deals with a method of displaying this information on a standard television screen commonly known as “Web television” or “Internet television”. FIG. 1 shows one configuration for the system. A television 20 is connected to a web appliance 30 typically through an audio-video cable. Someone skilled in the art will recognize that the web appliance signal can also be provided to the television through a television signal input. The web appliance 30 is connected to an internet connection. The internet connection can be though phone lines, coaxial cable, RF signals and so forth. With the web appliance 30 a viewer can watch television as normal, or can activate the web appliance 30 and view the internet through the television. In addition, a viewer can also have the capability to combine television viewing with the internet through interactive programming guides, and the linking of hyperlink web content to television content. The web appliance 30 has an accompanying remote control 40. Typically remote controls are small battery powered devices with a plurality of buttons having different functions. The remote control of the invention can transmit signals using infrared, or alternatively RF signals. Their use is desirable for a variety of reasons. Most television users are extremely comfortable and familiar with remote control technology and usage. Remote controls are extremely portable and can be used in a variety of body positions.

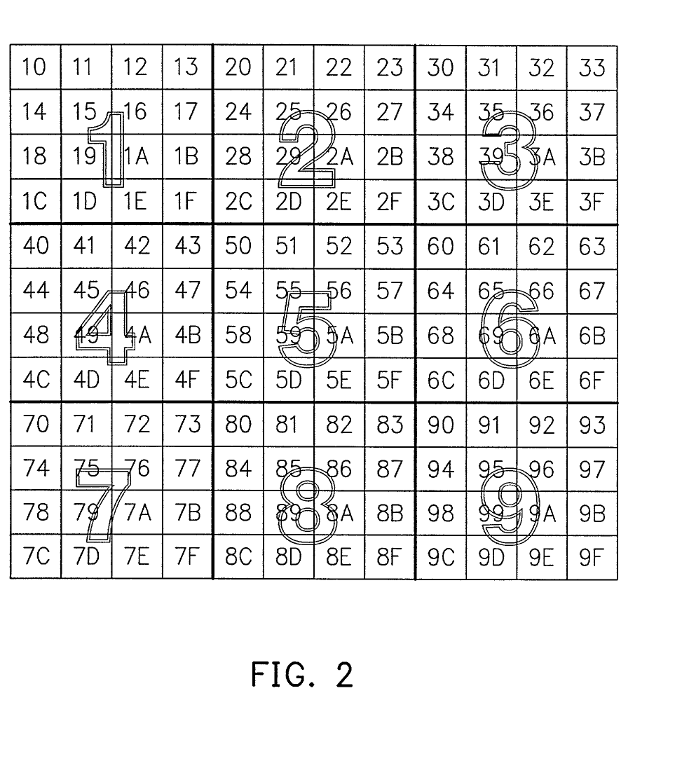

A method and apparatus will now be described for enhanced viewing and usage of internet information on a television screen using a remote control. A viewing screen is divided into a plurality of sections by graphical lines, each section denoted with an identifier such as a number for selection with a remote control. FIG. 2 shows the divisions used in a preferred embodiment of the invention. The screen is initially divided into 9 different sections each labeled with an identifier. The sections are defined by 2 horizontal lines, and 2 vertical lines dividing the viewing screen. In one embodiment the lines are added to the television display signal by the web appliance 30. In another embodiment of the invention the lines are a result of an external overlay on the screen surface placed there by the user. Each of the 9 sections is further divided into 16 additional blocks.

area 1 contains blocks 10, 11, 12, 13, 14, 15, 16, 17, 18, 19, 1A, 1B, 1C, 1D, 1E, 1F;

area 2 contains blocks 20, 21, 22, 23, 24, 25, 26, 27, 28, 29, 2A, 2B, 2C, 2D, 2E, 2F;

area 3 contains blocks 30, 31, 32, 33, 34, 35, 36, 37, 38, 39, 3A, 3B, 3C, 3D, 3E, 3F;

area 4 contains blocks 40, 41, 42, 43, 44, 45, 46, 47, 48, 49, 4A, 4B, 4C, 4D, 4E, 4F;

area 5 contains blocks 50, 51, 52, 53, 54, 55, 56, 57, 58, 59, 5A, 5B, SC, SD, 5E, 5F;

area 6 contains blocks 60, 61, 62, 63, 64, 65, 66, 67, 68, 69, 6A, 6B, 6C, 6D, 6E, 6F;

area 7 contains blocks 70, 71, 72, 73, 74, 75, 76, 77, 78, 79, 7A, 7B, 7C, 7D, 7E, 7F;

area 8 contains blocks 80, 81, 82, 83, 84, 85, 86, 87, 88, 89, 8A, 8B, 8C, 8D, 8E, 8F;

area 9 contains blocks 90, 91, 92, 93, 94, 95, 96, 97, 98, 99, 9A, 9B, 9C, 9D, 9E, 9F;

If a user wishes to enlarge a section for easier viewing the appropriate identifier can be inputted to the web appliance 30. The web appliance will then enlarge and display the selected section, along with parts of accompanying sections. For example is a user wants to focus on section 1, section 1 will be enlarged along with parts of adjoining areas 2, 4, and 5.

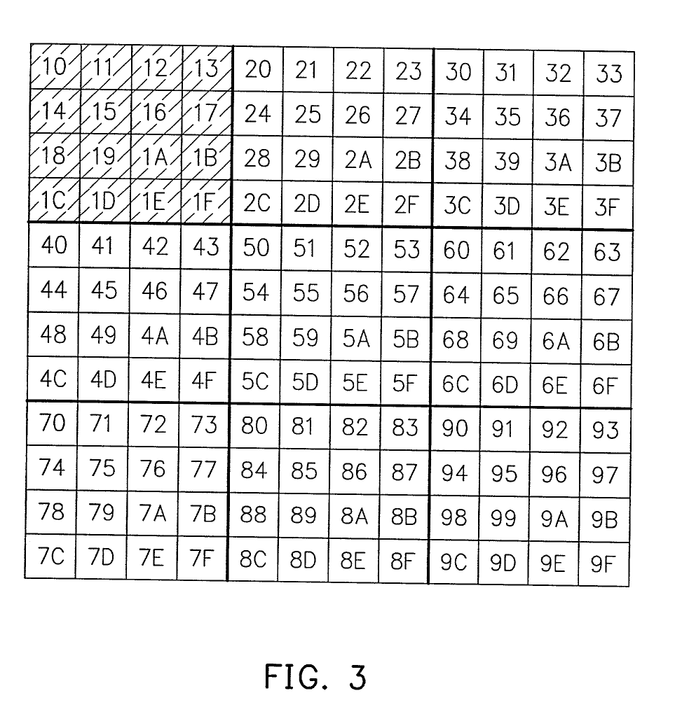

To focus in on section 1 as shown in FIG. 3:

A) section 1 will be enlarged:

block 10 will be upscaled to blocks 10, 11, 14, 15;

block 11 will be upscaled to blocks 12, 13, 16, 17;

block 12 will be upscaled to blocks 20, 21, 24, 25;

block 13 will be upscaled to blocks 22, 23, 26, 27;

block 14 will be upscaled to blocks 18, 19, 1C, 1D;

block 15 will be upscaled to blocks 1A, 1B, 1E, 1F;

block 16 will be upscaled to blocks 28, 29, 2C, 2D;

block 17 will be upscaled to blocks 2A, 2B, 2E, 2F;

block 18 will be upscaled to blocks 40, 41, 44, 45;

block 19 will be upscaled to blocks 42, 43, 46, 47;

block 1A will be upscaled to blocks 50, 51, 54, 55;

block 1B will be upscaled to blocks 52, 53, 56, 57;

block 1C will be upscaled to blocks 48, 49, 4C, SD;

block 1D will be upscaled to blocks 4A, 4B, 4C, 4D;

block 1E will be upscaled to blocks 58, 59, 5C, 5D;

block 1F will be upscaled to blocks 5A, 5B, SE, SF;

B) Part of area 2 will also be enlarged

block 20 will be upscaled to blocks 30, 31, 34, 35;

block 21 will be upscaled to blocks 32, 33, 36, 37;

block 24 will be upscaled to blocks 38, 39, 3C, 3D;

block 25 will be upscaled to blocks 3A, 3B, 3E, 3F;

block 28 will be upscaled to blocks 60, 61, 64, 65;

block 29 will be upscaled to blocks 62, 63, 66, 67;

block 2C will be upscaled to blocks 68, 69, 6C, 6D;

bock 2D will be upscaled to blocks 6A, 6B, 6E, 6F;

C) Part of area 4 will be enlarged:

block 40 will be upscaled to blocks 70, 71, 74, 75;

block 41 will be upscaled to blocks 72, 73, 76, 77;

block 42 will be upscaled to blocks 80, 81, 84, 85;

block 43 will be upscaled to blocks 82, 83, 86, 87;

block 44 will be upscaled to blocks 78, 79, 7C, 7D;

block 45 will be upscaled to blocks 7A, 7B, 7E, 7F;

block 46 will be upscaled to blocks 88, 89, 8C, 8D;

block 47 will be upscaled to blocks 8A, 8B, 8E, 8F;

D) Part of area 5 will be enlarged:

block 50 will be upscaled to blocks 90, 91, 94, 95;

block 51 will be upscaled to blocks 92, 93, 96, 97;

block 54 will be upscaled to blocks 98, 99, 9C, 9D;

block 55 will be upscaled to blocks 9A, 9B, 9E, 9F;

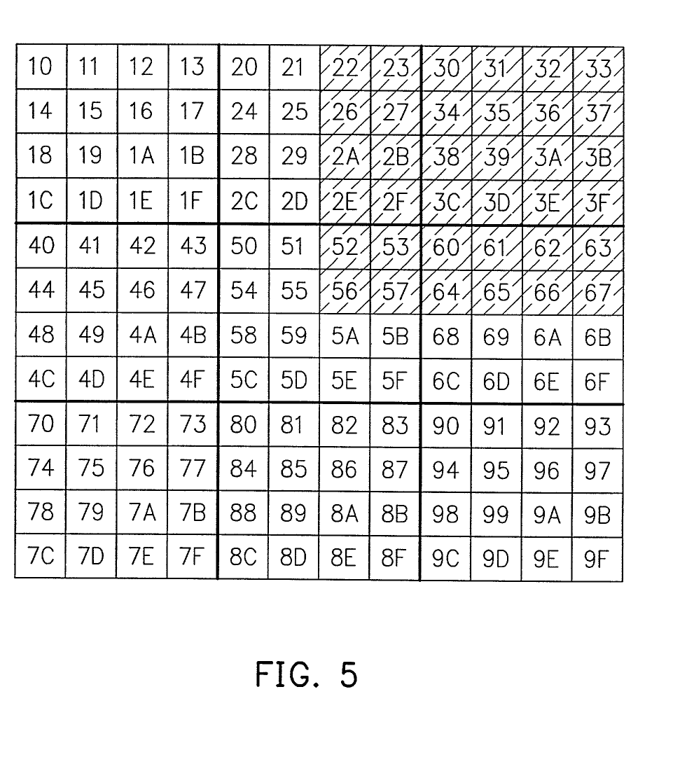

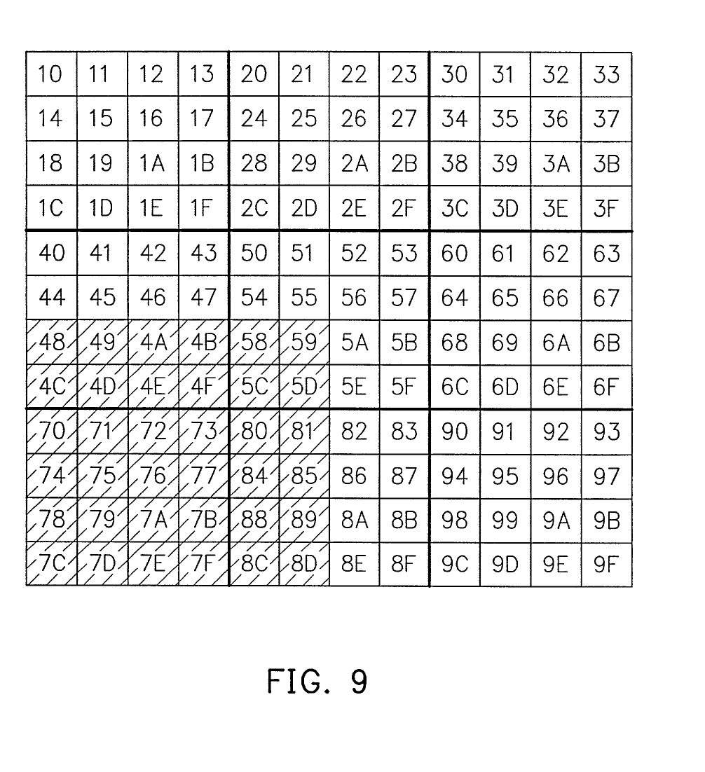

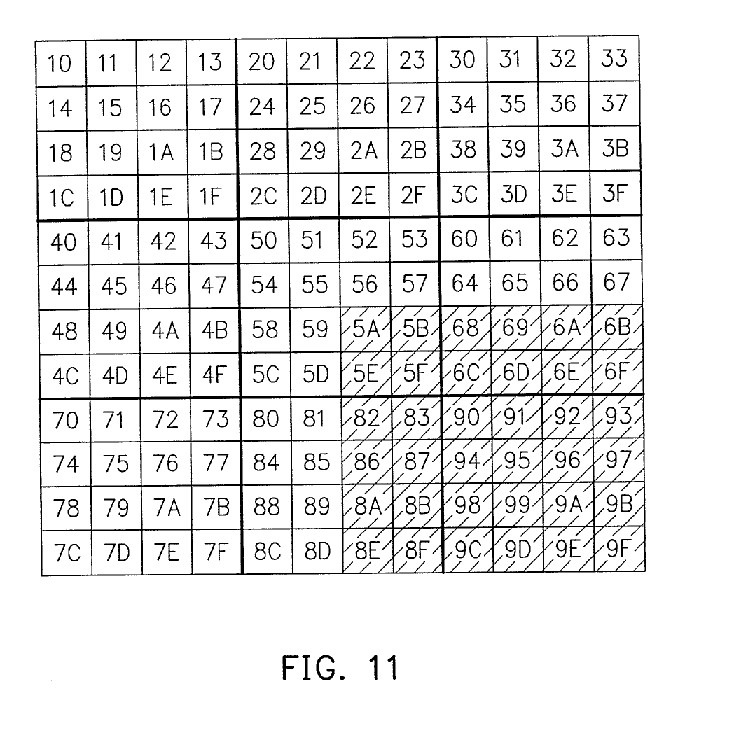

Area 3 (shown in FIG. 5), Area 7 (shown in FIG. 9), and Area 9 (shown in FIG. 11) are enlarged in a similar manner.

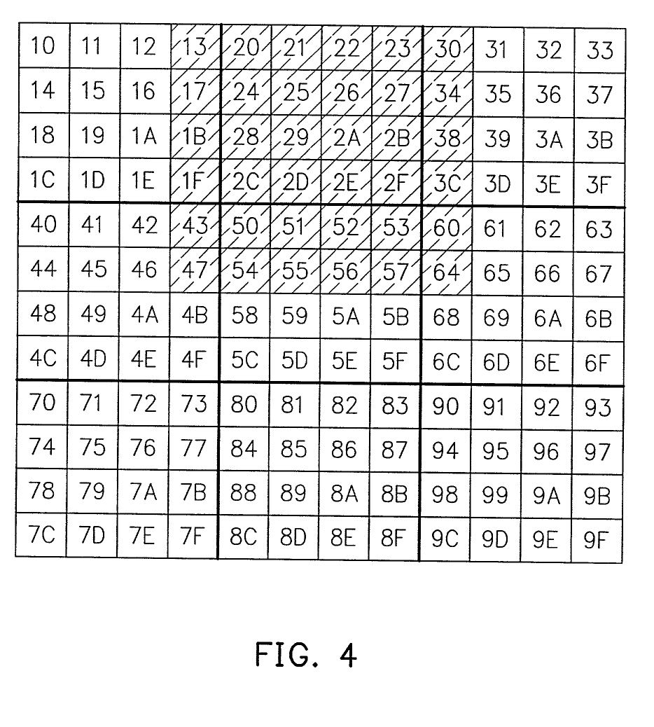

If we want to focus on area 2, we enlarge all of area 2 and parts of areas 1, 3, 4, 5, and 6 as shown in FIG. 4.

A) all of area 2 will be enlarged:

block 20 will be upscaled to blocks 12, 13, 16, 17;

block 21 will be upscaled to blocks 20, 21, 24, 25;

block 22 will be upscaled to blocks 22, 23, 26, 27;

block 23 will be upscaled to blocks 30, 31, 34, 35;

block 24 will be upscaled to blocks 1A, 1B, 1E, 1F;

block 25 will be upscaled to blocks 28, 29, 2C, 2D;

block 26 will be upscaled to blocks 2A, 2B, 2E, 2F;

block 27 will be upscaled to blocks 38, 39, 3C, 3D;

block 28 will be upscaled to blocks 42, 43, 46, 47;

block 29 will be upscaled to blocks 50, 51, 54, 55;

block 2A will be upscaled to blocks 52, 53, 56, 57;

block 2B will be upscaled to blocks 60, 61, 64, 65;

block 2C will be upscaled to blocks 4A, 4B, 4E, 4F;

block 2D will be upscaled to blocks 58, 59, 5C, 5D;

block 2E will be upscaled to blocks 5A, 5B, 5E, 5F;

block 2F will be upscaled to blocks 68, 69, 6C, 6D;

B) Part of area 1 will be upscaled:

block 13 will be upscaled to blocks 10, 11, 14, 15;

block 17 will be upscaled to blocks 18, 19, 1C, 1D;

block 1B will be upscaled to blocks 40, 41, 44, 45;

block 1F will be upscaled to blocks 48, 49, 4C, 4D;

C) Part of area 3 will be upscaled:

block 30 will be upscaled to blocks 32, 33, 36, 37;

block 34 will be upscaled to blocks 3A, 3B, 3E, 3F;

block 38 will be upscaled to blocks 62, 63, 66, 67;

block 3C will be upscaled to blocks 6A, 6B, 6E, 6F;

D) Part of area 4 will be upscaled:

block 43 will be upscaled to blocks 70, 71, 74, 75;

block 47 will be upscaled to blocks 78, 79, 7C, 7D;

E) Part of area 5 will be upscaled:

block 50 will be upscaled to blocks 72, 73, 76, 77

block 51 will be upscaled to blocks 80, 81, 84, 85;

block 52 will be upscaled to blocks 82, 83, 86, 87;

block 53 will be upscaled to blocks 90, 91, 94, 95;

block 54 will be upscaled to blocks 7A, 7B, 7E, 7F;

block 55 will be upscaled to blocks 88, 89, 8C, 8D;

block 56 will be upscaled to blocks 8A, 8B, 8E, 8F;

block 57 will be upscaled to blocks 98, 99, 9C, 9D;

F) Part of area 6 will be upscaled:

block 60 will be upscaled to blocks 92, 93, 96, 97;

block 64 will be upscaled to blocks 9A, 9B, 9E, 9F;

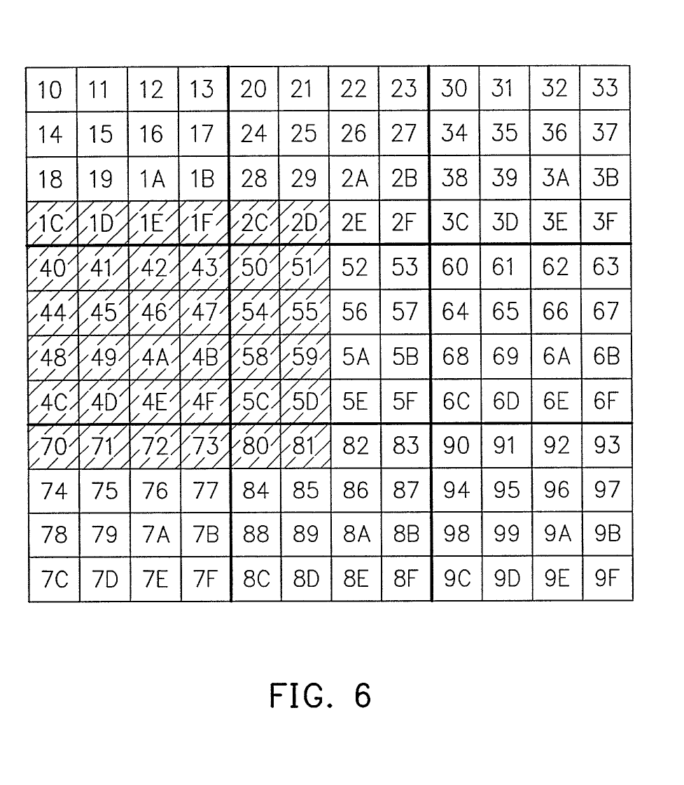

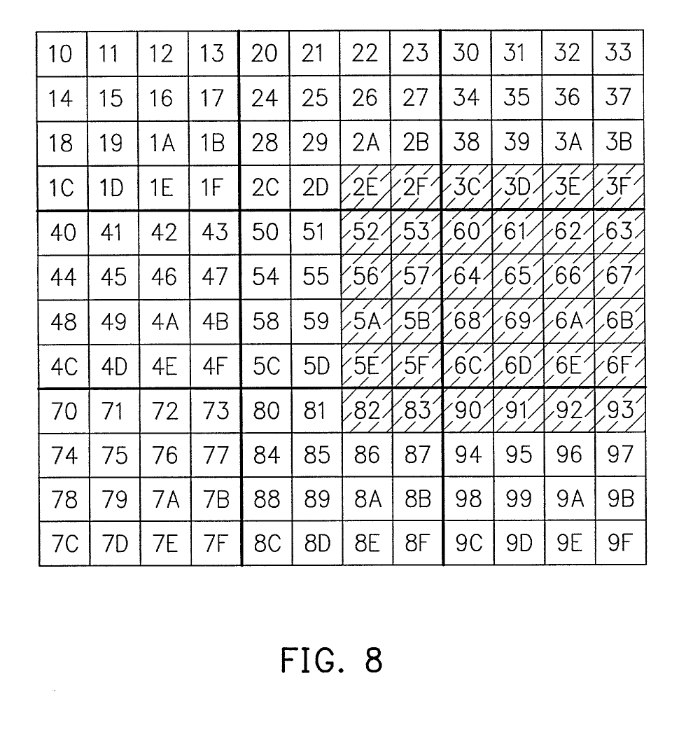

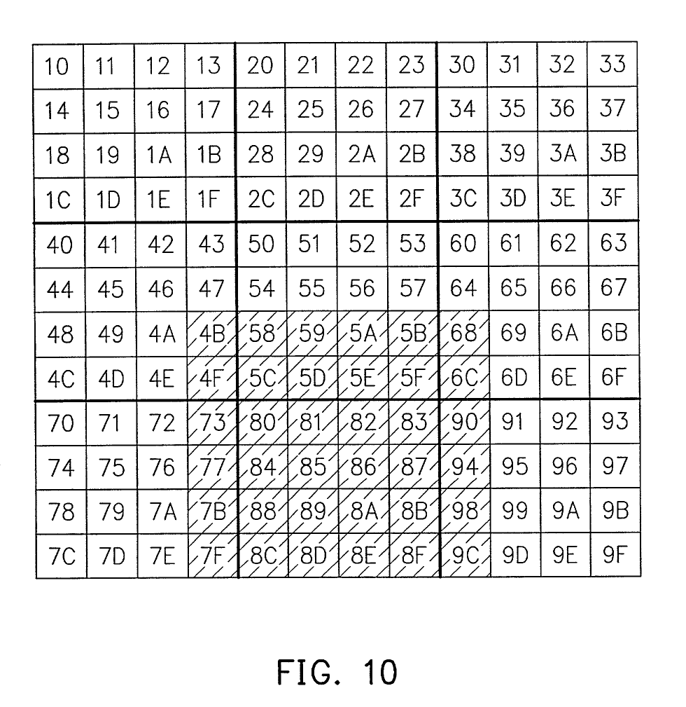

Area 4 (shown in FIG. 6), Area 6 (shown in FIG. 8), and Area 8 (shown in FIG. 10) will be enlarged in a similar manner.

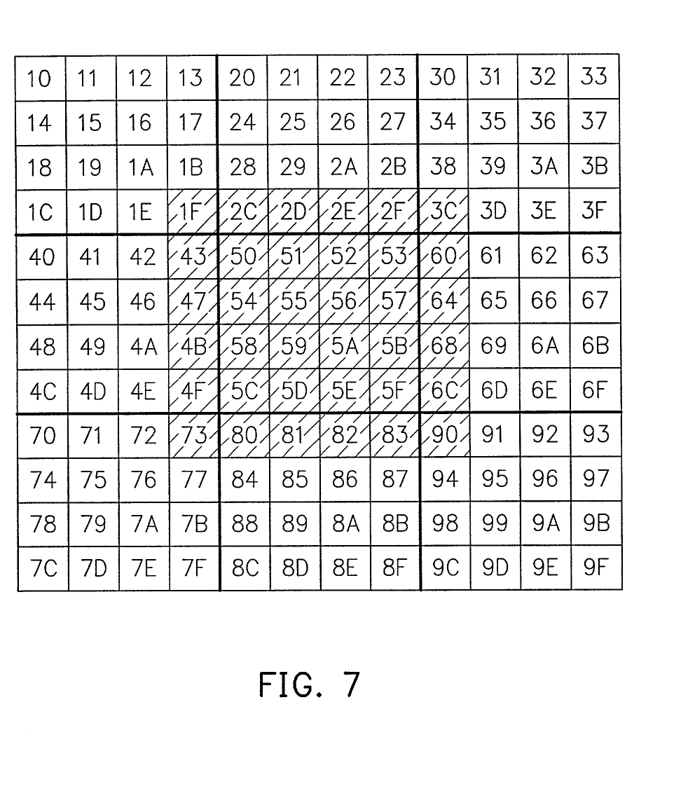

If we want to focus on area 5, we will enlarge all of area 5, and parts of areas 1, 2, 3, 4, 6, 7, 8, and 9 as shown in FIG. 7.

A) All of area 5 will be enlarged:

block 50 will be upscaled to blocks 1A, 1B, 1E, 1F;

block 51 will be upscaled to blocks 28, 29, 2C, 2D;

block 52 will be upscaled to blocks 2A, 2B, 2E, 2F;

block 53 will be upscaled to blocks 38, 39, 3C, 3D;

block 54 will be upscaled to blocks 42, 43, 46, 47;

block 55 will be upscaled to blocks 50, 51, 54, 55;

block 56 will be upscaled to blocks 52, 53, 56, 57;

block 57 will be upscaled to blocks 60, 61, 64, 65;

block 58 will be upscaled to blocks 4A, 4B, 4E, 4F;

block 59 will be upscaled to blocks 58, 59, 5C, 5D;

block 5A will be upscaled to blocks 5A, 5B, 5E, 5F;

block 5B will be upscaled to blocks 68, 69, 6C, 6D;

block 5C will be upscaled to blocks 72, 73, 76, 77;

block 5D will be upscaled to blocks 80, 81, 84, 85;

block 5E will be upscaled to blocks 82, 83, 86, 87;

block 5F will be upscaled to blocks 90, 91, 94, 95;

B) Part of area 1 will be upscaled:

block 1F will be upscaled to blocks 10, 11, 14, 15;

C) Part of area 2 will be upscaled:

block 2C will be upscaled to blocks 12, 13, 16, 17;

block 2D will be upscaled to blocks 20, 21, 24, 25;

block 2E will be upscaled to blocks 22, 23, 26, 27;

block 2F will be upscaled to blocks 30, 31, 34, 35;

D) Part of area 3 will be upscaled:

block 3C will be upscaled to blocks 32, 33, 36, 37;

E) Part of area 4 will be upscaled:

block 43 will be upscaled to blocks 18, 19, 1C, 1D;

block 47 will be upscaled to blocks 40, 41, 44, 45;

block 4B will be upscaled to blocks 48, 49, 4C, 4D;

block 4F will be upscaled to blocks 70, 71, 74, 75;

F) Part of area 6 will be enlarged:

block 60 will be upscaled to blocks 3A, 3B, 3E, 3F;

block 64 will be upscaled to blocks 62, 63, 66, 67;

block 68 will be upscaled to blocks 6A, 6B, 6E, 6F;

block 6C will be upscaled to blocks 92, 93, 96, 97;

G) Part of area 7 will be enlarged:

block 73 will be upscaled to blocks 78, 79, 7C, 7D;

H) Part of area 8 will be enlarged:

block 80 will be upscaled to blocks 7A, 7B, 7E, 7F;

block 81 will be upscaled to blocks 88, 89, 8C, 8D;

block 82 will be upscaled to blocks 8A, 8B, 8E, 8F;

block 83 will be upscaled to blocks 98, 99, 9C, 9D;

I) Part of area 9 will be enlarged:

block 90 will be upscaled to blocks 9A, 9B, 9E, 9F;

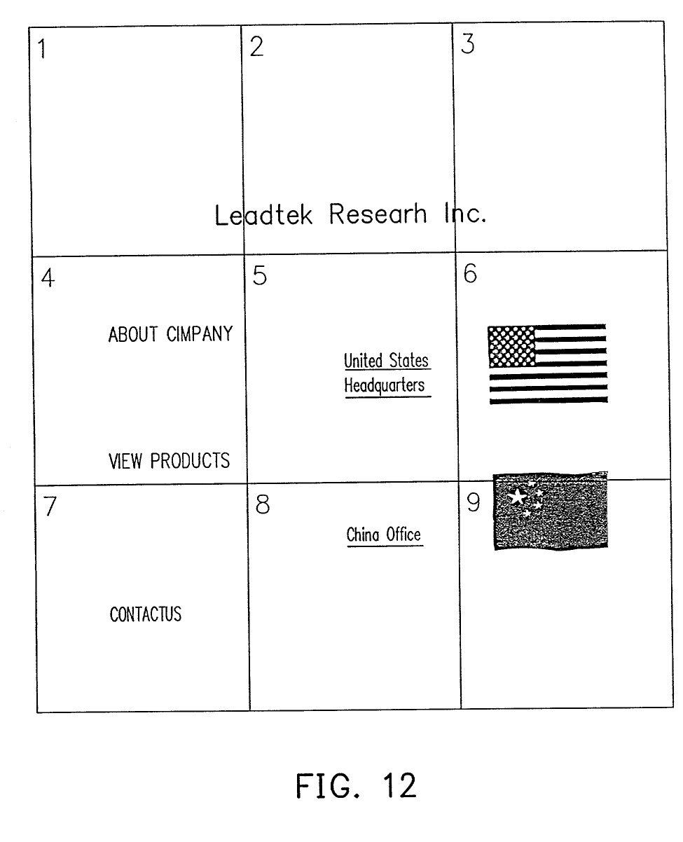

FIG. 12 shows a fictitious example of a web page. The screen is divided into 9 sections, each section identified by a number. If a user wishes to enlarge an area of the web page, the user will input an appropriate identifier (e.g. 2) to the system box 30, which will enlarge the corresponding section according to the method described hereinabove. When the screen is enlarged the lines and sections can appear on the enlarged version of the internet content which can then be further enlarged according to the method described hereinabove. The user will also have the option of descaling the current view to return to a previous version of the internet content.

In another embodiment of the invention the user will be able to select a link that appears in a section of the web page. For example in section 5 of the web page shown in FIG. 12 the link “United States Headquarters” appears. A user can select the link by inputting the identifier 5 to the system box 30.

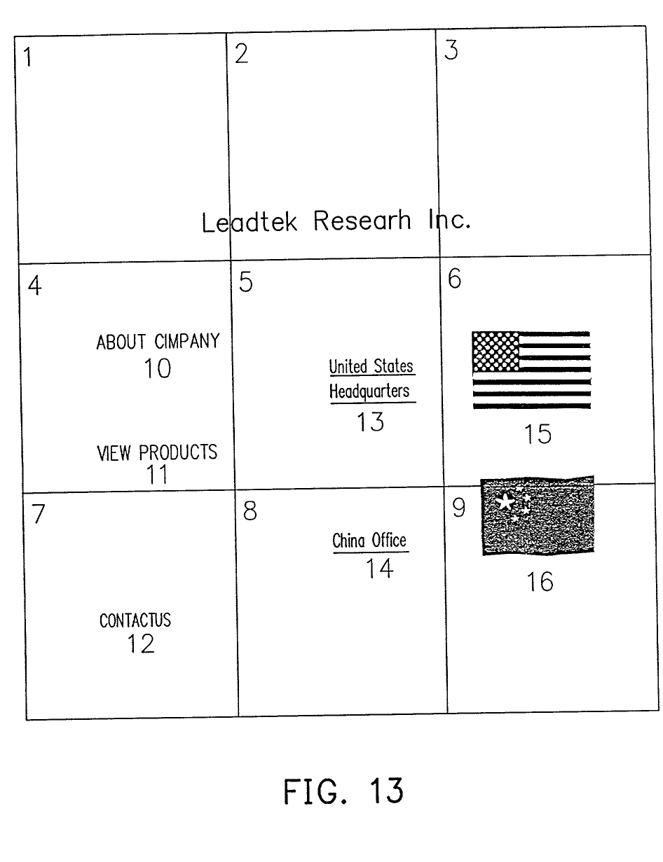

In another embodiment of the invention and as described in co-pending application an identifier such as a number as shown in FIG. 13 can appear beside each of the links. This will allow a user to both enlarge an area of a web page viewed on a television and to select a link using a remote control. For example if a user is having trouble reading the link “CONTACT US”, the user can input identifier 7 to the system box enlarging section 7 according to the method described hereinabove. The user can then select the link “CONTACT US” by inputting identifier 12 to the system box 30.

Various additional modifications may be made to the illustrated embodiments without departing from the spirit and scope of the invention. Therefore, the invention lies in the claims hereinafter appended.

What is claimed is:

1. A television-based internet viewing system, comprising:
a web appliance with an internet connection;
a television screen displaying internet content from the web appliance;
a plurality of lines interposed on the internet content displayed on the television screen dividing the viewing area into a plurality of selectable areas each with an identifier, wherein the web appliance is responsive to the identifier entered to perform steps of:
if an identifier is properly entered the corresponding viewing area being enlarged.

2. The television-based internet viewing system of claim 1, wherein the identifier is a number.

3. The television-based internet viewing system of claim 1, wherein the web appliance is responsive to an identifier inputted by a remote control device.

4. The television-based internet viewing system of claim 1, wherein the lines are added to the visual signal by the web appliance.

5. The television-based internet viewing system of claim 1, wherein the lines are an external overlay to the surface of the television screen.

6. The television-based internet viewing system of claim 1, wherein the identifiers are added to the visual signal by the web appliance.

7. A method for viewing internet content on a television screen, the method comprising:
adding a plurality of graphical lines to an internet content display dividing the internet content into a plurality of sections;
adding a corresponding identifier to each of the sections;
enlarging a selected sections along with bordering areas to the size of the previous displayed internet content responsive to an inputted identifier.

8. A television-based internet viewing system comprising:
a web appliance with an internet connection;
a television screen displaying internet content from the web appliance;
a plurality of graphical lines interposed on the internet content displayed on the television screen dividing the viewing area into a plurality of selectable areas each with an identifier;
a remote control device in which a desired identifier can be transmitted by the user, the web appliance being responsive to the identifier entered, if an identifier is properly entered a link in the corresponding selectable area being chosen.

9. The television-based internet viewing system of claim 7, wherein the identifier is a number.

10. The television-based internet viewing system of claim 7, wherein the lines are added to the visual signal by the web appliance.

11. The television-based internet viewing system of claim 7, wherein the lines are an external overlay to the surface of the television screen.

12. The television-based internet viewing system of claim 7, wherein the identifiers are added to the visual signal by the web appliance.

13. A method for viewing internet content on a television screen comprising the steps of:
adding a plurality of graphical lines to an internet content display dividing the internet content into a plurality of sections;
adding a corresponding identifier to each of the sections; and
selecting a link appearing in a selected section of the internet content responsive to an inputted identifier.

14. A web appliance, comprising:
a means to add a plurality of graphical lines and identifiers to internet content;
a means to display the modified internet content on a television screen;
a means to enlarge a desired area of the internet content as selected by a user and display the enlarged area on the television screen; and
a means to select a link appearing in a defined area of the internet content as selected by a user.

15. The web appliance of claim 14, wherein the identifier is a number.

16. The web appliance of claim 14, wherein the lines are added to the visual signal by the web appliance.

17. The web appliance of claim 14, wherein the lines are an external overlay to the surface of the television screen.

18. The web appliance of claim 14, wherein the identifiers are added to the visual signal by the web appliance.
